(19) United States
(12) Patent Application Publication
(10) Pub. No.: US 2009/0276379 A1
(43) Pub. Date: Nov. 5, 2009

(54) Using automatically generated decision trees to assist in the process of design and review documentation

(76) Inventors: Rachel Tzoref, Haifa (IL); Hana Chockler, Haifa (IL); Eitan Daniel Farchi, Pardes (IL)

Correspondence Address: MAXVALUEIP CONSULTING LLC, 11204 ALBERMYRTLE ROAD, POTOMAC, MD, 20854, US

(21) Appl. No.: 12/114,809

(22) Filed: May 4, 2008

(51) Int. Cl. G06F 15/18

(52) U.S. Cl. 706/12

(57) ABSTRACT

An embodiment of this invention is to use automatically generated decision trees to assist in the design and review process. In one embodiment, the decision trees are automatically extracted from data describing a system (in case of design process) or a review artifact (in case of review process). In a further embodiment, the decision trees are then used in the design process, and the order of attributes in the decision tree suggests a new order for writing the design document.

### RELATED APPLICATION

This application is related to another Accelerated Application with the same assignee and common inventor(s), filed on the same date, titled “Reverse engineering from code and decision trees to a high level model”.

### BACKGROUND OF THE INVENTION

We use automatically-generated decision trees, in order to generate possible orders of design elements of a system, and to generate various artifacts according to these orders. The key difficulty in determining the best order is that a system, viewed diagrammatically, is a graph, that is, defines only a partial order between its elements. There can be many possible extensions of this partial order to the total order, required in order to describe the system in the design document. There are several (related) problems that our embodiment solves:
Figuring the best order of explanation of the system's design elements and its logic—needed for writing readable design documents.
Figuring the best order of execution so that the logic is minimal and concise—needed for writing high-level algorithms.
Review—having more than one artifact at hand enables to compare between them; however, all artifacts should describe precisely the same thing.
Review—due to the lack of time, often we wish to review only a part of execution paths of the system; thus, for review, the system should be presented in a way that makes extracting these paths easy and straightforward.

Design documents are written manually, and as such, figuring the best order is left to the designer. Moreover, review of long documents is difficult. In addition, when using UML for design, there is no good solution for the ordering.

### SUMMARY OF THE INVENTION

An embodiment of this invention provides features to use automatically generated decision trees to assist in the design and review process. In one embodiment, the decision trees are automatically extracted from data describing a system (in case of design process) or a review artifact (in case of review process). In another embodiment, the decision trees are then used as follows: in the design process, the order of attributes in the decision tree suggests a new order for writing the design document. In the review process, the decision tree contributes in the following ways: (in no specific order)
1. It is a different artifact to study and compare
2. By using different restrictions on the data, can create a tree containing the parts of the artifact that are of most interest (handy for long review artifacts and short review sessions)
3. By using weights on the attributes, can guide the order so that the attributes that are of most interest come first
4. By using weights on the values of the attributes, can guide it, so that the most common cases come first

### BRIEF DESCRIPTION OF THE DRAWINGS

FIG. 1 is a schematic diagram of modeling the system.

FIG. 2 is a schematic flow diagram in generating decision trees to assist in the process of design and review documentation.

### DETAILED DESCRIPTION OF THE PREFERRED EMBODIMENTS

An embodiment of invention is comprised of the following steps:
Modeling the system or the review artifact by transforming the data representing them into the following format:
   1. A set of attributes, each attribute has a set of possible values
   2. A classification of the attributes into inputs (observations about the system/review artifact) and outputs (conclusions)
   3. A set of assignments—each assignment gives values to all attributes
   4. Additionally: a set of constraints on the possible assignments to the attributes
   5. Additionally: attach weights to the input attributes, according to their importance
   6. Additionally: attach weights to the values of an attribute, according to their frequency
   7. Additionally: use pruning of the tree.
      Pruning is a well known technique used by algorithms for creating decision trees. For example, if pruning of 80% is used, then a leaf of the decision tree is created when at least 80% of the assignments in the sub tree have the same output values.
Creating a decision tree for the data. The nodes of the decision tree are the input attributes, the leaves of the tree is the output attribute, and the outgoing edges of a node are marked with the corresponding attribute's values. If more than one output attribute exists, the output is the Cartesian product of all output attributes. The decision tree is generated by using well-known algorithms for decision tree generation such as id3 and c4.5. These algorithms generate a decision tree in which the value of the output is determined as quickly as possible. This is done by choosing at each node level the attribute that will gain most information (advances most towards determining the value of the output).
Showing the decision tree to the designer/reviewers. The decision tree is then compared to the original artifact, and different questions are raised, for example:
   1. Whether the tree indeed represents the system/artifact. If not—why. Is there a fault in the design, and is there a fault in the modeling of the design?
   2. Whether the tree describes the system/artifact in a more compact or useful way than the original description. If so—maybe the new description should be adopted.
   3. Whether some new insights or invariants about the system/artifact can be extracted from observing the system/artifact, possibly these invariants were implicit and hard to figure out in the previous description.
Changing the generated decision tree:
   1. By changing the constraints, concentrate on different parts of the system/artifact. For example, by constraining to normal paths, error paths are excluded from the tree.
   2. The original decision tree algorithm disregards any additional information about the attributes, for example, if there is a hierarchy between them, or what are the most common values of an attribute. This makes the generated tree a good source of comparison to the original design/review artifact.
However, if the user wants to add additional information about the attributes, it can be done in the following ways:
   1. By giving weights on the attributes, determine a subset of the attributes to appear first (higher) in the tree. (For example, according to hierarchy.)
   2. By attaching weights to the values of an attribute, give precedence to the common cases.
   3. By changing the pruning parameter, can generate decision trees with different levels of accuracy. If no pruning is used, then the decision tree precisely describes the data. If pruning is used, the tree is a generalization of the data, and this generalization can emphasize properties of the data that are not obvious when observing the accurate tree.

In one embodiment, the invention can be implemented on top of any tool that is used for design and/or review and has a list of attributes and their values.

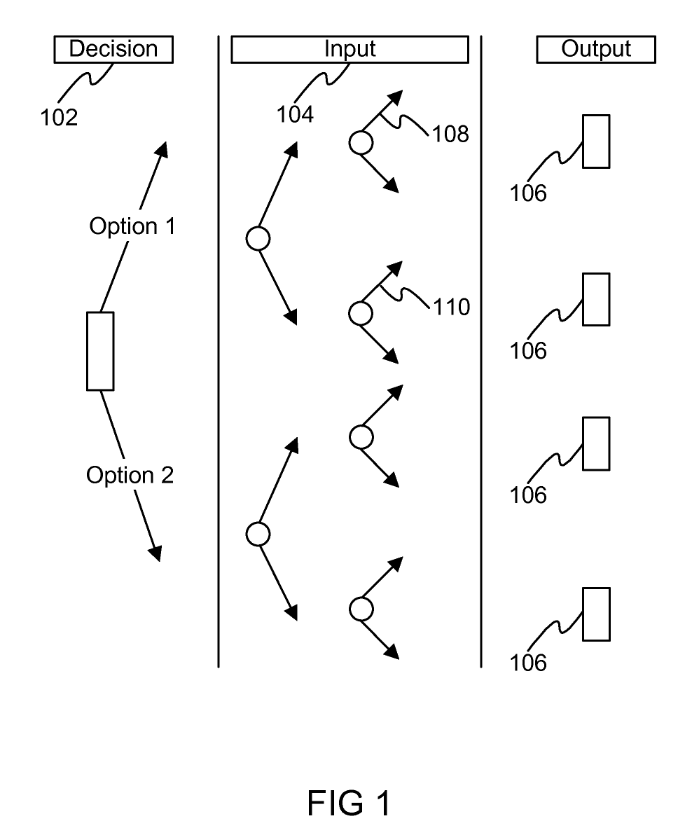

In one embodiment, the invention (FIG. 1) is a schematic diagram of modeling the system by transforming the data representing a set of attributes, each attribute has a set of possible values (108 and 110): A classification of the attributes into inputs (104) and outputs/conclusions (106); A set of assignments—each assignment gives values to all attributes; Additionally a set of constraints on the possible assignments to the attributes; Additionally attach weights to the input attributes (104), according to their importance; Additionally attach weights to the values of an attribute, according to their frequency; and Additionally use pruning of the tree. Pruning is a well known technique used by algorithms for creating decision trees. For example, if pruning of 80% is used, then a leaf of the decision tree is created when at least 80% of the assignments in the sub tree have the same output values, and finally the decision (102) is made based on the automatically generated decision trees.

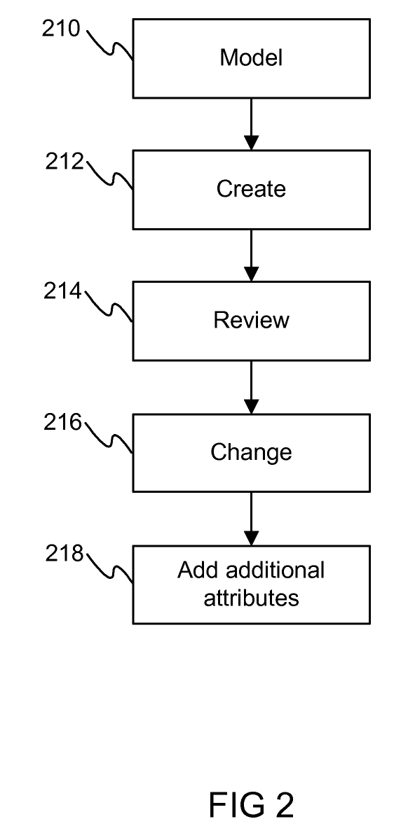

FIG. 2 is a schematic diagram illustrating the flow in generating decision trees to assist in the process of design and review documentation. The flow comprises:
1. Modeling the system or the review artifact by transforming the data (210).
2. Creating a decision tree for the data(212)
3. Showing the decision tree to the designer/reviewers (214).
4. Changing the generated decision tree after review (216).
5. However, additional information can be added if the user wants (218).
One embodiment of the invention is a method of using automatically generated decision trees to assist in the process of design and review documentation, the method comprising:
modeling a system or a review artifact to create a model;
creating a generic decision tree based on the model;

comparing the generic decision tree to the system or the review artifact and analyzing any discrepancy between the generic decision tree and the system or the review artifact; and creating a constrained decision tree; wherein the model comprising:
a set of input attributes;
a set of output attributes;
a set of assignments, assigning values to the set of input attributes;
a set of constraints on the set of assignments;
a set of first weights corresponding to the set of input attributes based on importance;
a set of second weights corresponding to the values based on frequency; and a set of pruning parameters; wherein the generic decision tree and the constrained decision tree comprising one or more nodes representing the set of input attributes, and one or more leaves representing the set of output attributes; wherein resulting output is the Cartesian product of all the set of output attributes if the set of output attributes has more than one member; wherein the constrained decision tree is created by changing the set of constraints, by assigning the set of first weights, by assigning the set of second weights, or by changing the set of pruning parameters; wherein the constraint decision tree is created for figuring out the best order of explanation of design elements and logic needed for writing readable the design and review documentation, for figuring out the best order of execution so that the logic is minimal and concise for writing high-level algorithms, for generating and comparing two or more of review artifacts, or for reviewing only a part of execution path of the system or the review artifact.

A system, apparatus, or device comprising one of the following items is an example of the invention: decision tree, model, design, set of assignments, assigning module, modeling module, output, input, member, applying the method mentioned above, for purpose of decision tree and design and review documentation.

Any variations of the above teaching are also intended to be covered by this patent application.

1. A method of using automatically generated decision trees to assist in the process of design and review documentation, said method comprising:
modeling a system or a review artifact by a modeling module;
automatically creating a generic decision tree based on a model;
comparing said generic decision tree to said system or said review artifact and analyzing any discrepancy between said generic decision tree and said system or said review artifact; and
creating a constrained decision tree;
wherein said model comprising:
a set of input attributes for high-level algorithms in a computer system;
a set of output attributes for said high-level algorithms in said computer system;
a set of assignments, assigning values to said set of input attributes by an assigning module;
a set of constraints on said set of assignments;
a set of first weights corresponding to said set of input attributes based on importance;
a set of second weights corresponding to said values based on frequency; and
a set of pruning parameters;
wherein said generic decision tree and said constrained decision tree comprising one or more nodes representing said set of input attributes, and one or more leaves representing said set of output attributes;
taking Cartesian product of all said set of output attributes if said set of output attributes has more than one member;
wherein said constrained decision tree is created by changing said set of constraints, by assigning said set of first weights, by assigning said set of second weights, or by changing said set of pruning parameters;
wherein said constrained decision tree is created for figuring out the best order of explanation of design elements and logic needed for writing readable said design and review documentation, for figuring out the best order of execution so that said logic is minimal and concise for writing high-level algorithms, for generating and comparing two or more of review artifacts, or for reviewing only a part of execution path of said system or said review artifact.
